(19) United States
(12) Patent Application Publication
(10) Pub. No.: US 2018/0071881 A1
(43) Pub. Date: Mar. 15, 2018

(54) METHOD FOR MANUFACTURING GLASS PLATE, GLASS PLATE, AND DISPLAY DEVICE

(71) Applicant: Asahi Glass Company, Limited, Tokyo (JP)

(72) Inventors: Mitsuru HORIE, Chiyoda-ku (JP); Masabumi ITO, Chiyoda-ku (JP); Yuki HORI, Chiyoda-ku (JP)

(73) Assignee: Asahi Glass Company, Limited, Tokyo (JP)

(21) Appl. No.: 15/813,339

(22) Filed: Nov. 15, 2017

Related U.S. Application Data
(63) Continuation of application No. PCT/JP2016/065920, filed on May 30, 2016.

(30) Foreign Application Priority Data
Jun. 12, 2015 (JP) 2015-118863

(51) Int. Cl. B24B 13/01; C03C 19/00

(52) U.S. Cl. CPC B24B 13/01; C03C 19/00

(57) ABSTRACT

A method for manufacturing a glass plate including a polishing step of polishing a curved surface of the glass plate using a polisher; wherein the polisher is a rotating brush including a rotating core and brush bristles provided on an external surface of the rotating core, an average diameter of the brush bristle being not more than 300 μm, and wherein in the polishing step, a position of the rotating brush relative to the glass plate is reciprocated along an axial direction of the rotating brush at a reciprocating speed of not less than 1 mm/sec and a reciprocating amplitude of not less than 0.5 mm.

### CROSS-REFERENCE TO RELATED APPLICATION

This application is a continuation application of International Application PCT/JP2016/065920 filed on May 30, 2016, and designated the U.S., which claims priority of Japanese Patent Application No. 2015-118863 filed on Jun. 12, 2015. The entire contents of the foregoing applications are incorporated herein by reference.

### BACKGROUND OF THE INVENTION

### 1. Field of the Invention

The present invention relates to a manufacturing method of a glass plate, a glass plate, and a display device.

### 2. Description of the Related Art

Japanese Laid-Open Patent Publication No. 08-141898 disclose a technique for polishing a curved surface of a glass plate using a rubber sleeve. The rubber sleeve is made of rubber, and is formed into a hollow cylindrical shape. When the rubber sleeve is being used, air is supplied inside the rubber sleeve to keep an internal air pressure constant. During a course of polishing, the rubber sleeve deforms elastically such that the rubber sleeve adheres to the glass plate.

Japanese Laid-Open Patent Publication No. 09-57599 disclose a technique for polishing a curved surface of a glass plate using a rotating drum. In this technique, the curved surface of the glass plate can be polished by varying a center position of the rotating drum relative to a center of the glass plate in accordance with the rotating angle of the glass plate.

Japanese Examined Patent Application Publication No. 08-22498 discloses a technique for polishing a curved surface of a glass plate using a polishing pad. In the polishing pad, multiple elastic members are contained. During the course of polishing, the polishing pad deforms elastically such that the polishing pad adheres to the glass plate.

### CITATION LIST

### Patent Literature

[PTL 1] Japanese Laid-Open Patent Publication No. 08-141898,

[PTL 2] Japanese Laid-Open Patent Publication No. 09-57599,

[PTL 3] Japanese Laid-Open Patent Publication No. 08-22498.

### SUMMARY OF THE INVENTION

When polishing a curved surface of a glass plate using a rubber sleeve, a rotating drum, a polishing pad, and the like, polishing speed is not high. Therefore, it takes a long time to remove a large defect on the glass plate.

The present invention is made in light of the above problems, and provides a manufacturing method of a glass plate capable of removing a large defect in a short time.

According to an aspect of the present invention, there is provision for a method for manufacturing a glass plate including a polishing step of polishing a curved surface of the glass plate using a polisher. The polisher is a rotating brush including a rotating core and brush bristles provided on an external surface of the rotating core. An average diameter of the brush bristle is not more than 300 μm. In the polishing step, a position of the rotating brush relative to the glass plate is reciprocated along an axial direction of the rotating brush at a reciprocating speed of not less than 1 mm/sec and reciprocating amplitude of not less than 0.5 mm.

According to an aspect of the present invention, a manufacturing method of a glass plate capable of removing a large defect in a short time can be provided.

### BRIEF DESCRIPTION OF THE DRAWINGS

Other objects, features and advantages of the present invention will become more apparent from the following detailed description when read in conjunction with the accompanying drawings.

FIG. 1 is a diagram illustrating a manufacturing method of a glass plate according to an embodiment;

FIG. 2 is a cross-sectional view taken along a line II-II in FIG. 1;

FIG. 3 is a drawing illustrating a polished glass plate according to the embodiment;

FIG. 4 is a drawing illustrating an end portion of a polished glass plate which was obtained by applying a polishing method as described in example 1;

FIG. 5 is a view illustrating a manufacturing method of a glass plate according to comparative example 2; and

FIG. 6 is a drawing illustrating a polished glass plate which was obtained by applying a polishing method as described in comparative example 2.

### DETAILED DESCRIPTION OF THE PREFERRED EMBODIMENTS

In the following, with reference to drawings, embodiments of the present invention will be described. In each drawing, the same reference symbol is assigned to the same component, and redundant explanation will be omitted. In the present specification, notation such as “A-B” or “A to B” may be used when expressing a range of a value. When a range of a value is described as “A-B” or “A to B”, it means that A and B are included in the range. That is, “A-B” or “A to B” means that values not less than A and not more than B are included in the range.

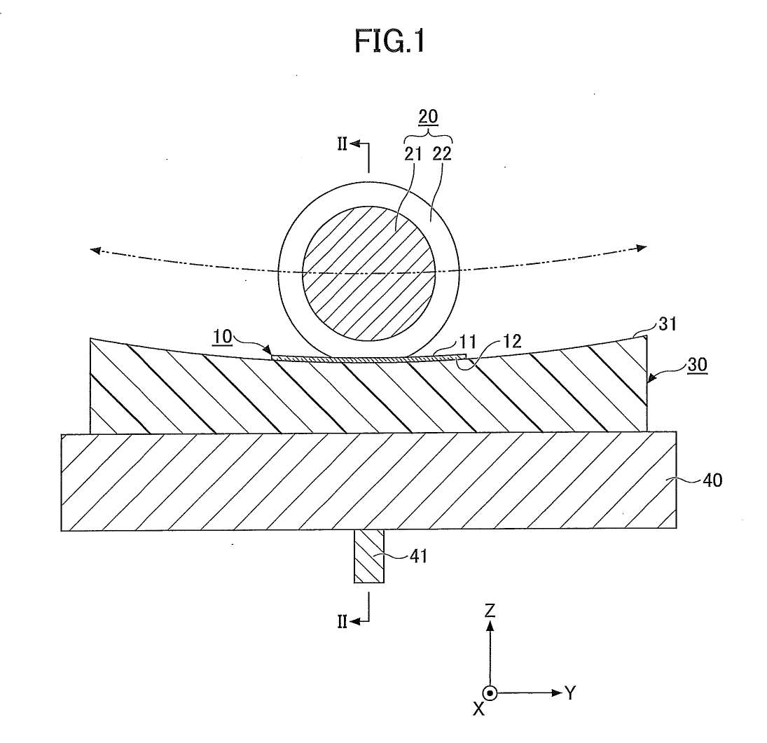

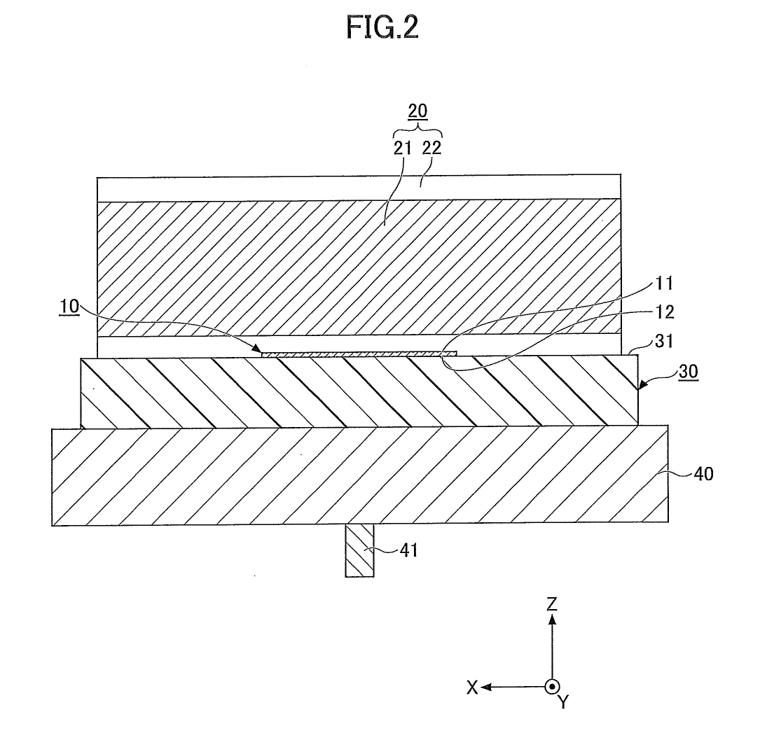

FIG. 1 is a diagram illustrating a manufacturing method of a glass plate according to an embodiment. In FIG. 1, a dashed double-dotted line represents a trajectory of a center axis of a rotating brush 20 when the rotating brush 20 is moved. FIG. 2 is a cross-sectional view taken along a line II-II in FIG. 1. In FIG. 2 and FIG. 2, an X-direction, a Y-direction, and a Z-direction are orthogonal to each other. The X-direction represents a direction of the center axis of the rotating brush 20, the Z-direction represents a vertical direction, and the Y-direction represents a direction orthogonal to both the X-direction and the Z-direction.

The manufacturing method of a glass plate illustrated in FIGS. 1 and 2 includes a step of polishing a curved surface 11 of a glass plate 10 using the rotating brush 20 which acts as a polisher.

The glass plate 10 may be used for various purposes. For example, the glass plate 10 may be used for a vehicle or a display monitor. The glass plate 10 may be used for any type of display monitors, such as a cathode-ray tube display, a liquid crystal display, a plasma display, or an organic EL display. The display monitor includes a display device used for a cellular phone.

The glass plate 10 may be curved in entirety. For example, the glass plate 10 may be a part of a cylindrical body. Note that the glass plate 10 may be partially curved. That is, only a part of the glass plate 10 may be curved and the rest of the glass plate 10 may be flat.

The glass plate 10 includes the curved surface 11. A minimum radius of curvature is, for example, 30-10000 mm at any point on the curved surface 11, preferably 100-10000 mm, more preferably 300-10000 mm, and further more preferably 500 to 5000 mm.

Note that the radius of curvature of a point on the curved surface 11 represents a radius of curvature of a curve obtained by cutting the curved surface 11 by a plane including a normal from the point on the curved surface 11. The radius of curvature may vary between a minimum value and a maximum value, when the plane (including the normal from the point on the curved surface 11) is rotated around the normal. Alternatively, the radius of curvature may not vary, that is, a minimum and a maximum of the radius of curvature may be the same.

The curved surface 11 of the glass plate 10 curves in cross-sectional view perpendicular to the X-direction as illustrated in FIG. 1, and may be flat in cross-sectional view perpendicular to the Y-direction as illustrated in FIG. 2. In this case, the radius of curvature of the curved surface 11 at the cross-section perpendicular to the X-direction becomes smallest, and becomes largest at the cross-section perpendicular to the Y-direction. Note that the maximum of the radius of curvature is infinity in this case.

In the present embodiment, the curved surface 11 of the glass plate 10 is flat in cross-sectional view perpendicular to the Y-direction, but the curved surface 11 may be curved in another embodiment.

The curved surface 11 of the glass plate 10 is concave upward in cross-sectional view perpendicular to the X-direction, as illustrated in FIG. 1. But in another embodiment, the curved surface 11 of the glass plate 10 may be convex upward.

The rotating brush includes a rotating core 21 and brush bristles 22 provided on an external surface of the rotating core 21. Multiple brush bristles 22 are provided on the rotating core 21. In FIGS. 1 and 2, a white region represents a bundle of the brush bristles 22.

The rotating core 21 is formed in a cylindrical shape. In this case, the external surface of the rotating core 21 is even in cross-sectional view perpendicular to the Y-direction, as illustrated in FIG. 2. Since the external surface of the rotating core 21 is even, every brush bristle 22 provided on the rotating core 21 along the X-direction from one end to the other end of the rotating core 21 can have the same length, so that non-uniformity of polishing can be reduced.

If the curved surface 11 of the glass plate 10 is curved in cross-sectional view perpendicular to the Y-direction, the external surface of the rotating core 21 may also be curved. The rotating core 21 may be formed such that a center portion is thicker than end portions. Alternatively, the rotating core 21 may be formed such that a center portion is thinner than end portions. When the external surface of the rotating core 21 is formed as described here, every brush bristle 22 provided on the rotating core 21 along the X-direction from one end to the other end of the rotating core 21 can have the same length, so that non-uniformity of polishing can be reduced.

The brash bristles 22 may be planted in the external surface of the rotating core 21, or the brush bristles 22 may be attached on a clamp wound on the external surface of the rotating core 21. The brush bristles 22 are formed of a resin or the like. Length of each brush bristle 22 may be approximately the same. When a minimum radius of the rotating core 21 is smaller than a minimum radius of curvature of a surface to be polished, the surface can be polished uniformly, so that a glass plate having a good polished surface can be obtained.

An average diameter of the brush bristles 22 is not more than 300 μm, for example. When an average diameter of the brush bristles 22 is not more than 300 μm, waviness of the curved surface 11 after polishing can be reduced. Further, since the brush bristles 22 are easily bent, the curved surface 11 is less likely to be damaged when jamming by contaminants occurs. An average diameter of the brush bristles 22 is preferably not more than 200 μm, and more preferably not less than 100 μm.

Length of the brush bristles 22 is preferably not less than 2 mm, and more preferably not less than 5 mm. When the length of the brush bristles 22 is not less than 2 mm, contact pressure by elasticity of the brush bristles 22, which occurs when the brush bristles 22 are pressed to a surface to be polished, will not be too strong, so that a polished surface of little damage can be obtained. Further, length of the brush bristles 22 is preferably not more than 100 mm, and more preferably not more than 50 mm. When the length of the brush bristles 22 is not more than 100 mm, appropriate contact pressure by elasticity of the brush bristles 22 can be obtained when the brush bristles 22 are pressed to a surface to be polished. Accordingly, speed of polishing will improve.

In a polishing step, the curved surface 11 of the glass plate 10 is polished, by rotating the rotating brush 20 on the center axis. At this step, slurry including abrasive grain is supplied with the rotating brush 20. As abrasive grain, for example, particles of cerium oxide are used. Other than cerium oxide, aluminum oxide, zirconium oxide, iron oxide, silicon oxide, or the like, may be used. A polishing speed using the rotating brush 20 is higher than a polishing speed using a rubber sleeve, a rotating drum, a polishing pad, or the like. Therefore a removal of a large defect can be completed in a short time.

In the polishing step, a position of the rotating brush 20 relative to the glass plate 10 is moved along the curved surface 11, in cross-sectional view perpendicular to the X-direction as illustrated in FIG. 1. Accordingly, the entire curved surface 11 can be polished.

This relative movement of the rotating brush 20 may be realized by moving the rotating brush 20, moving the glass plate 10, or moving both the rotating brush 20 and the glass plate 10. FIG. 1 illustrates an example in which the relative movement of the rotating brush 20 is realized by moving the rotating brush 20. A trajectory of the rotating brush 20 will be a curved shape.

FIG. 1 illustrates a case in which the relative movement of the rotating brush 20 is performed such that a distance between the center axis of the rotating brush 20 and the curved surface 11 of the glass plate 10 is kept constant. But alternatively, the relative movement may be performed such that contact pressure between the rotating brush 20 and the curved surface 11 of the glass plate 10 is kept constant.

In order not to form linear polishing traces by the relative movement, a position of the rotating brush 20 relative to the glass plate 10 is reciprocated along the X-direction in the polishing step. The reciprocating may be performed by to-and-fro movement of the rotating brush 20, the glass plate 10, or both the rotating brush 20 and the glass plate 10. FIG. 1 illustrates an example in which the reciprocating is realized by to-and-fro movement of the glass plate 10.

Speed of the reciprocating is, not less than 1 mm/sec for example, and preferably not less than 2 mm/sec. Further, the speed of the reciprocating is preferably not more than 50 mm/sec. Note that the speed of the reciprocating is represented by speed of the rotating brush 20 when passing a center point of amplitude of the reciprocating motion. Further, amplitude of the reciprocating is, for example, not less than 0.5 mm, preferably not less than 3 mm, and much more preferably not less than 5 mm. In addition, the amplitude of the reciprocating motion is preferably not more than 200 mm. The amplitude of the reciprocating motion means a maximum displacement from the center point of the reciprocating.

By reciprocating a position of the rotating brush 20 relative to the glass plate 10 along the X-direction at a speed not less than 1 mm/sec and an amplitude not less than 0.5 mm, forming of linear polishing traces on the curved surface 11 of the glass plate 10 can be reduced.

Polishing by the rotating brush 20 is especially suitable when anti-glare coating is applied to the glass plate 10 after polishing. Anti-glare coating can make linear polishing traces invisible from the outside. Anti-glare coating is, for example, applied to the glass plate 10 for vehicles.

In the polishing step, an opposite surface 12 of the glass plate 10, which is on the opposite side of the curved surface 11, may be vacuum-adhered to a curved surface 31 of a base 30, to stabilize a shape of the curved surface 11 of the glass plate 10 during polishing. By the curved surface 11 being vacuum-adhered to the curved surface 31 of the base 30, the glass plate 10 can be easily detached from the base 30 after polishing.

The base 30 may be made of, for example, carbon or metals. However, it is preferable that the base 30 is made of a resin material of at least one of polyvinyl chloride, polycarbonate, polyacetal, acryl, polyamide, polyurethane, polypropylene, and polyethylene. As these resin materials are soft, causing of damage on the glass plate 10 by the base 30 can be reduced. Further, the entire base 30 need not be formed of the material described above. At least a portion of the base 30 with which the glass plate 10 is in contact may be formed of the material described above. Alternatively, the portion of the base 30 may be made of an elastic body such as rubber.

A shape of the curved surface 31 of the base 30 is approximately the same as that of the curved surface 11 of the glass plate 10. For example, the curved surface 31 of the base 30 may curve in cross-sectional view perpendicular to the X-direction as illustrated in FIG. 1, and may be flat in cross-sectional view perpendicular to the Y-direction as illustrated in FIG. 2. Note that the shape of the curved surface 31 of the base 30 is not necessarily the same as that of the curved surface 11 of the glass plate 10. The curved surface 31 may be a shape corresponding to the opposite surface 12.

The curved surface 31 of the base 30 is concave upward in cross-sectional view perpendicular to the X-direction, as illustrated in FIG. 1. Note that the shape of the curved surface 31 of the base 30 should be approximately the same as that of the curved surface 11 of the glass plate 10. The shape of the curved surface 31 may be convex upward.

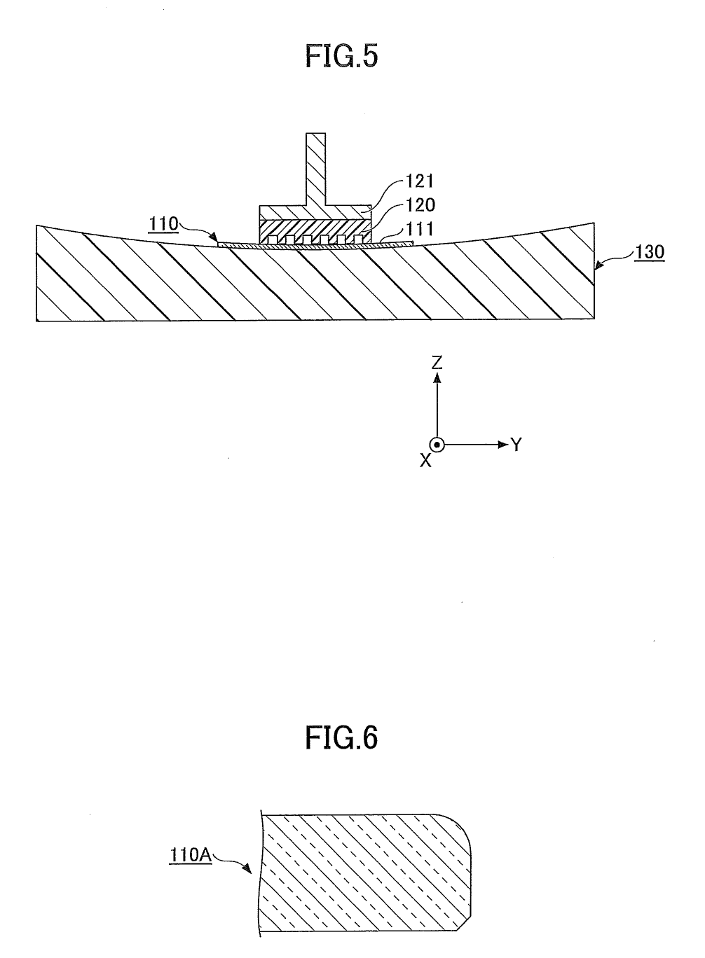

Also, a recessed portion in which the glass plate 10 can be fitted may be formed at the surface of the base 30 where the glass plate 10 is placed. The recessed portion can prevent the glass plate 10 from sliding on the base 30 by the rotating brush 20 dragging the glass plate 10, and thereby can reduce scratches to be made on the glass plate 10. Further, occurrence of a case, as illustrated in FIG. 6, in which a chamfer of the glass plate 10 becomes round by concentrating a pressure at the chamfer, can be reduced.

Further, a recess may be formed in a side wall surface of the recessed portion. When the recess is formed, the glass plate 10 after polishing can be easily removed from the recessed portion by inserting a turner in the recess. Accordingly, the recess improves efficiency for exchanging the glass plate 10.

In the polishing step, the glass plate 10 may be reciprocated by to-and-fro movement of the base 30 along the X-direction. As described above, forming of linear polishing traces on the curved surface 11 of the moving the glass plate 10 can be reduced by the reciprocating.

In the polishing step, the glass plate 10 may be rotated by rotating the base 30. Forming of linear polishing traces on the curved surface 11 of the glass plate 10 can be further reduced by the rotation.

A direction of the rotation may be kept in the same direction, or may be reversed repeatedly. When the direction of the rotation is reversed repeatedly, the glass plate 10 may be rotated within a predetermined range less than 360 degrees.

The base 30 is mounted on a turn table 40, and is rotated with the turn table 40. The turn table 40 can freely rotate on a rotating axis 41.

In the present embodiment, only one surface of the glass plate 10 is polished, but in another embodiment, another surface may be polished. Further, both surfaces of the glass plate 10 may be polished.

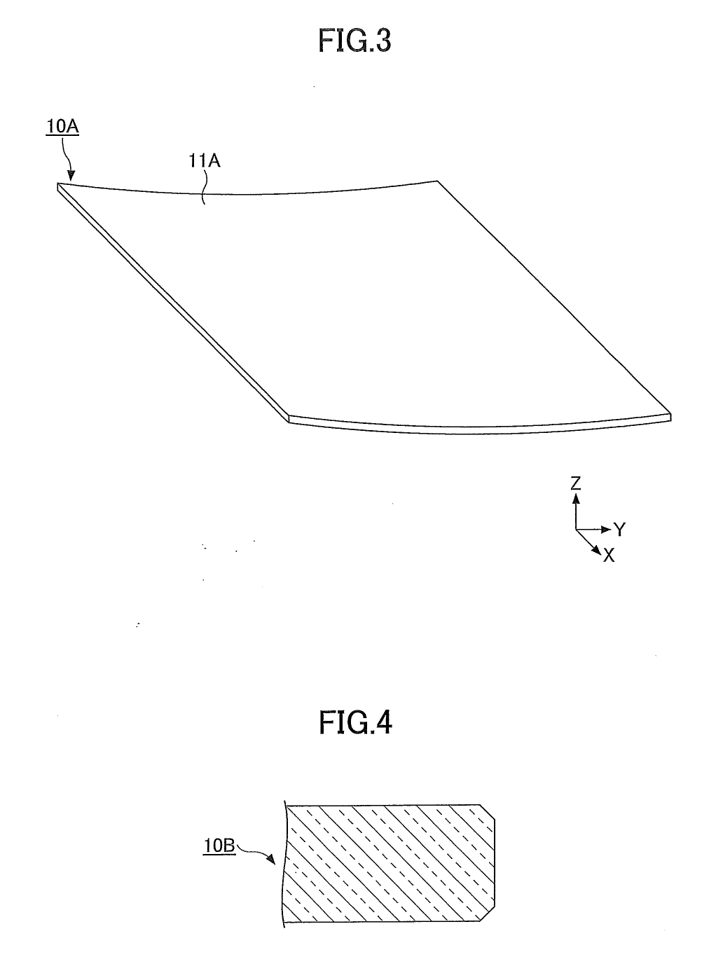

FIG. 3 is a drawing illustrating a polished glass plate according to the present embodiment. A glass plate 10A illustrated in FIG. 3 is obtained by polishing the glass plate 10 illustrated in FIG. 1 or FIG. 2 using the rotating brush 20. A thickness of the glass plate 10A is 0.5-5.0 mm for example, preferably 0.5-3.0 mm, and more preferably 0.7-2.5 mm.

The glass plate 10A includes a polished curved surface 11A. The glass plate 10A may be curved in entirety. Alternatively, the glass plate 10A may be partially curved. That is, only a part of the glass plate 10A may be curved and the rest of the glass plate 10A may be flat.

On at least a part of the curved surface 11A of the glass plate 10A, an arithmetical mean height (Sa) of a frequency component corresponding to a wavelength range from 25 to 500 μm is 0.5-50 nm. A Gaussian filter is used to extract a frequency component. The curved surface 11A having the arithmetical mean height (Sa) ranging from 0.5 to 50 nm can be formed by polishing the curved surface 11A using the rotating brush 20.

The arithmetical mean height (Sa) is measured in accordance with an international standard (ISO 25178). A cutoff value of a high-pass filter is 25 μ, and a cutoff value of a low-pass filter is sufficiently smaller than a minimum radius of curvature of the curved surface 11A of the glass plate 10A.

On at least a part of the curved surface 11A of the glass plate 10A, a ratio (Waₘₐₓ/Waₘᵢₙ) of a maximum (Waₘₐₓ) to a minimum (Waₘᵢₙ) of an arithmetical mean waviness (Wa) of a frequency component corresponding to a wavelength range from 25 to 500 μm is not less than 1.5. The ratio (Waₘₐₓ/Waₘᵢₙ) is preferably not less than 1.6, and not more than 10.

The arithmetical mean waviness (Wa) is measured in accordance with a (Japanese Industrial Standard (JIS B0601: 2013). A cutoff value of a high-pass filter is 25 μm, and a cutoff value of a low-pass filter is 500 μm. The cutoff value of the low-pass filter is sufficiently smaller than a minimum radius of curvature of the curved surface 11A of the glass plate 10A. Hence, a reference surface of the arithmetical mean waviness (Wa) may be a flat plane which is approximately in parallel with an XY-plane.

The arithmetical mean waviness (Wa) is measured along a linear measuring path on the reference surface. If the measuring path is rotated around a Z-axis, the arithmetical mean waviness (Wa) that is measured varies between the minimum (Waₘᵢₙ) and the maximum (Waₘₐₓ).

When the ratio (Waₘₐₓ/Waₘᵢₙ) is not less than 1.5, it represents that the curved surface 11A is formed by polishing the curved surface 11A using the rotating brush 20. The arithmetical mean waviness (Wa) which is measured along the measuring path perpendicular to the X-direction tends to be smallest (Waₘᵢₙ).

On at least a part of the curved surface 11A of the glass plate 10A, the number of defects whose maximum diameter is not less than 7 μm and whose depth or height is not less than 1 μis less than 4 per 10000 mm². The polishing speed using the rotating brush 20 is higher than the polishing speed when using a rubber sleeve, a rotating drum, a polishing pad, or the like. Therefore a removal of a large defect can be completed in a short time, and the number of large defects can be reduced.

### EXAMPLE

### Example 1

A glass plate made of soda-lime glass, and having a minimum radius of curvature of 1500 mm, a length of 150 mm, a width of 150 mm, and a thickness of 1 mm, was prepared. This glass plate was a part of a cylindrical body, which curved in cross-sectional view perpendicular to the X-direction and was flat in cross-sectional view perpendicular to the Y-direction. This glass plate had chamfers having a bevel angle of 45 degrees and a chamfering width of 0.1 mm, at a boundary between an upper surface and an end surface and a boundary between a lower surface and the end surface respectively. The bevel angle is an angle formed by an extension surface of the upper or lower surface and the chamfer. Also, the chamfering width is a distance from an edge of the upper or lower surface to an intersection point between an extended plane of the upper or lower surfaces and an extended plane of the end surface, which represents a size of the chamfer.

A rotating brush having a cylindrical rotating core and brush bristles provided on an external surface of the rotating core was prepared. Each brush bristle was made of nylon 66, and an average diameter and an average length of the brush bristles were 200 μm and 20 mm, respectively. A diameter of the rotating brush was 150 mm.

In a polishing step, the upper surface of the glass plate was polished by thickness of 5 μm while rotating the rotating brush on its center axis at a rotation speed of 900 rpm. During the polishing step, the glass plate was vacuum-adhered to a base so that a shape of the upper surface of the glass plate was maintained in an upward concave curved surface. Further, during the polishing step, slurry including particles of cerium oxide was supplied with the rotating brush.

In the polishing step, the center axis of the rotating brush was moved along the upper surface of the glass plate, in cross-sectional view perpendicular to the X-direction at a speed of 1 mm/sec. During the moving, the rotating brush was moved such that a distance between the center axis of the rotating brush and the upper surface of the glass plate was kept constant (which is 6 mm shorter than a radius of the rotating brush).

In the polishing step, the glass plate was reciprocated by reciprocating the base in the X-direction. A reciprocating speed was 15 mm/sec, and amplitude of the reciprocating was 13 mm. Note that rotation of the base was not performed. By performing the polishing step described above, glass plate A was obtained.

After the polishing, the glass plate was cleaned and dried, and then the arithmetical mean height (Sa) and the arithmetical mean waviness (Wa) of the glass plate were measured using a white-light interferometric flatness meter. The measurement was performed on an area of 3.6 mm squared at a central portion of the glass plate.

The arithmetical mean height (Sa) of the glass plate was 7 nm. Also, regarding the arithmetical mean waviness (Wa) of the glass plate, a minimum (Waₘᵢₙ) was 2.8 nm, a maximum (Waₘₐₓ) was 5.1 nm, and a ratio of the maximum to the minimum (Waₘₐₓ/Waₘᵢₙ) was 1.8.

It took 25 minutes to polish the glass plate by a thickness of 5 μm. A defect having a maximum diameter not leas than 7 μm and a depth or a height not less than 1 μm was not found on the polished surface of the glass plate.

FIG. 4 is a drawing illustrating an end portion of a polished glass plate which was obtained by applying the polishing method as described in example 1. Shapes pf chamfers of a polished glass plate 10B were kept flat, as illustrated in FIG. 4. The reason presumed is that the brush bristles having an average diameter of 200 μm do not apply strong stress to the chamfers or the glass plate .

### Comparative Example 1

In comparative example 1, a glass plate was polished similarly to the example 1 except that an average diameter of brush bristles of the rotating brush was 400 μm and that a base was not reciprocated. By polishing the glass plate, a glass plate B was obtained.

As a result of the experiment in comparative example 1, the arithmetical mean height (Sa) of the glass plate was 70 nm. Also, regarding the arithmetical mean waviness (Wa) of the glass plate, a minimum (Waₘᵢₙ) was 4 nm, a maximum (Waₘₐₓ) was 100 nm, and a ratio of the maximum to the minimum (Waₘₐₓ/Waₘᵢₙ) was 25.

It took 25 minutes to polish the glass plate by a thickness of 5 μm. 10 defects having a maximum diameter not less than 7 μm and a depth or a height not less than 1 μm were found on a polished surface of the glass plate per 10000 mm².

### Comparative Example 2

In comparative example 2, a same glass plate (hereinafter referred to as a glass plate 110) as the glass plate used in example 1 was prepared, and a curved surface 111 of the glass plate 110 was polished using a polishing pad 120 as illustrated in FIG. 5. A circular base which is made of SUS304 stainless steel having a diameter of 60 mm was prepared as a polishing head 121. The polishing pad 120 made of polyurethane was attached to a tip of the polishing head 121. The polishing pad 120 that was used here had multiple grooves on its surface, which was in contact with the glass plate 110, and each of the grooves was arranged at intervals of 10 mm so as to form a grid.

In a polishing step, the polishing pad 120 was pressed against the glass plate 110 with a pressure of 150 g/cm² at a rotation speed of 150 rpm. During the polishing step, the glass plate 110 was vacuum-adhered to a base 130 so that a shape of the upper surface (curved surface 111) of the glass plate 110 was maintained in an upward concave curved surface. Slurry including particles of cerium oxide was supplied with the polishing pad 120. The polishing pad 120 was moved on the glass plate 110 in the X-direction and the Y-direction at a speed of 60 mm/sec, to polish the entire curved surface 111 by a thickness of 5 μm. It took 300 minutes to polish the glass plate 110. By polishing the glass plate 110 as described above, a glass plate C was obtained.

As a result of the experiment in comparative example 2, the arithmetical mean height (Sa) of the glass plate 110 was 1.6 nm. Also, regarding the arithmetical mean waviness (Wa) of the glass plate 110, a minimum (Waₘᵢₙ) was 1.5 nm, a maximum (Waₘₐₓ) was 2 nm, and a ratio of the maximum to the minimum (Waₘₐₓ/Waₘᵢₙ) was 1.3. A defect having a maximum diameter not less than 7 μm and a depth or a height not less than 1 μm was not found on the polished surface of the glass plate 110.

FIG. 6 is a drawing illustrating a polished glass plate which was obtained by applying the polishing method as described in comparative example 2. Shapes of chamfers of a polished glass plate 110A were not kept flat, but became round, as illustrated in FIG. 6. The reason presumed is that strong stress was applied to the chamfers of the glass plate 110A when the polishing pad was in contact with the chamfers.

Next, visibility of an image was checked for each of the glass plates A, B, and C obtained by the above described experiments (example 1, comparative example 1, and comparative example 2), when the glass plates were used as cover glasses of a display device. The display devices were made in accordance with the following steps. First, OCA tapes (“MHM-FWD” made by NICHIEI KAKOH CO., LTD.) were adhered on surfaces opposite to the polished surfaces of the glass plates A, B, and C, respectively. Second, each of the glass plates A, B, and C was adhered on a liquid crystal panel which is used as a display panel. Third, combining the display panel with a backlight and the like, the display devices were prepared. With respect to the display device in which the glass plate A was used, when an image on the liquid crystal panel was seen via the glass plate A, no distortion, waviness, or flicker was recognized visually. As reasons that no distortion, waviness, or flicker was recognized, the following factors are presumed. First , since a ratio of the arithmetical mean waviness (Waₘₐₓ/Waₘᵢₙ) was small (1.8), the distortion or the waviness of an image was reduced. Second, since the arithmetical mean height (Sa) was smell (7 nm), the flicker of an image was reduced. With respect to the display device in which the glass plate B was used, waviness was recognized on a part of an image, and an image blur caused by flicker was recognized. As reasons that waviness and a blur were recognized, the following factors are presumed. First, since the ratio of the arithmetical mean waviness (Waₘₐₓ/Waₘᵢₙ) was large (that is, 25), image distortion occurred. Second, since the arithmetical mean height (Sa) was large (that is, 70 nm), the flicker of an image occurred. With respect to the display device in which the glass plate C was used, as image visibility at a center portion of the glass plate C was as good as that of the glass plate A. However, as the chamfers had also been polished, although an image could be recognized at a periphery of the glass plate C, the image appeared distorted. With respect to the glass plate C, through the ratio of the arithmetical mean waviness (Waₘₐₓ/Waₘᵢₙ) and the arithmetical mean height (Sa) were small, the chamfers at the periphery of the glass plate C became of curved shape. Therefore, visibility of the periphery of the glass plate C became different from visibility of the center portion of the glass plate C, and an image seen at the periphery was distorted. As a result of the check, it was proved that the glass plate A is suitable for a cover glass used as a display device.

As described above, by using a method according to the present embodiments, a glass plate having less defects can be obtained.

### Modified Example

As described above, the preferred embodiments of the method of manufacturing the glass plate and the like have been described. However, the present invention is not limited to the above-described specific embodiments, and various variations and modifications may be made without deviating from the scope of the present invention, described in claims.

A glass plate before polishing need not have chamfers at an outer circumference portion, but it is preferable that chamfers are provided at the outer circumference portion, to prevent the outer circumference portion from being broken during polishing. Before polishing, a shape of the chamfer is preferably flat, though it may be curved. This is because the size variation of the chamfer before and after polishing is lessened. A bevel angle of the flat shape chamfer is 40-50 degrees for example.

Further, when polishing a glass plate having a small radius of curvature polishing may be performed with the radius of curvature enlarged by applying an external force to the glass plate. As the external force which is applied to the glass plate, for example, suction of the glass plate to a base may be used.

The rotating brush according to the present embodiment can polish a plane having a radius of curvature larger than 10000 mm. Also, a glass plate including both a curved surface and a flat surface on the surface to be polished can be polished by moving a position of the rotating brush relative to the surface to be polished. A glass plate including both a concave surface and a convex surface on the surface to be polished can also be polished. A minimum radius of the rotating core of the rotating brush should preferably be not larger than a minimum radius of curvature of the surface to be polished. Further, a complex curved surface curved in cross-sectional view perpendicular to a Y-direction, in addition to cross-sectional view perpendicular to an X direction as illustrated in FIG. 1, can be polished.

The polishing method according to the present embodiment is superior in that a glass plate having a large curved surface can be polished. In the conventional polishing method, as polishing on a perportion basis is required, variation in uniformity of polishing occurs. In the polishing method according to the present embodiment, glass plates having various sizes can be uniformly polished by changing a size of the rotating brush.

It is preferable that a surface of a glass plate obtained by the polishing method according to the present embodiment is smooth. For example, from perspectives of visibility and tactile sensation, it is preferable that an arithmetic mean deviation of roughness profile (Ra) is 0.2 nm-50 nm. From perspectives of roughness and finger sliding property, it is preferable that a root mean square deviation of roughness profile (Rq) is 0.3 nm-100 nm. From perspectives of roughness and finger sliding property, it is preferable that a maximum height of roughness profile (Rz) is 0.5 nm-100 nm. From perspectives of roughness and finger sliding property, it is preferable that a total height of roughness profile (Rt) is 1 nm-500 nm. From perspectives of roughness and finger sliding property, it is preferable that a maximum profile peak height of roughness profile (Rp) is 0.3 nm-500 nm. From perspectives of roughness and finger sliding property, it is preferable that a maximum profile valley depth of roughness profile (Rv) is 0.3 nm-500 nm. From perspectives of roughness and finger sliding property, it is preferable that a mean width of roughness profile elements (Rsm) is 0.3 nm-100 nm. From a perspective of a tactile sensation, it is preferable that a kurtosis of roughness profile (Rku) is 1-3. From perspectives of uniformity of visibility, tactile sensation, and the like, it is preferable that a skewness of roughness profile (Rsk) is between −1 and 1.

Various processes may be applied to the glass plate obtained by the polishing method according to the present embodiment. As described earlier, chamfering process using a grinding stone or acid may be performed either before or after the polishing. Or, the chamfering process may be performed both before and after the polishing. Also, a surface treatment layer may be formed on the glass plate before or after the polishing by applying surface treatment. Specific examples of the surface treatment layer include an anti-glare coating layer formed by etching or deposition, an antireflective coating layer, a soil resistant layer formed by an anti-fingerprint coating agent or the like, a defogging layer, and the like. When the glass plate is to be polished after surface treatment, only a surface to which surface treatment was not applied should be polished. When surface treatment is to be applied after the polishing, both of the surfaces should preferably be polished, though at least one of the surfaces may be polished. By performing the polishing, the glass plate having uniform surface can be obtained, thereby making a surface treatment having desired characteristics easier. A toughening process of the glass plate, preferably a chemical toughening process, may be applied before or after the polishing, If a chemical toughening process is applied after the polishing, the glass plate is uniformly strengthened. If a chemical toughening process is applied before the polishing, hardened damages that occurred on the surface of the glass plate can be removed. Therefore, the polishing may be performed either before or after a chemical toughening process, depending on circumstances. Processes applied to the glass plate are not limited to the above described processes. Various other processes may be applied. Further, the order of the process to be applied to the glass plate may be determined as appropriate.

Examples of glass used as the glass plate are, for example, alkali-free glass or soda-lime glass, when no chemical toughening process may be performed. When a chemical toughening process may be performed, soda-lime glass, soda-lime silicate glass, aluminosilicate glass, borate glass, lithium aluminosilicate glass, and borosilicate glass are examples of composition of the glass plate. As for aluminosilicate glass, even thin aluminosilicate glass can bear strong stress by applying a toughening process, and can be made into a strong glass plate. Also, because of these features, aluminosilicate glass is suitable for a cover glass of the display device. Therefore, aluminosilicate glass is preferable for the glass plate.

As composition of the glass, one example is a glass containing SiO₂ of 50-80 mol %, Al₂O₃ of 0.1-25 mol %, Li₂O+Na₂O+K₂O of 3-30 mol %, MgO of 0-25 mol %, CaO of 0-25 mol %, and ZrO₂ of 0-5 mol %, but the glass is not limited to this composition. More specifically, examples include the following composition of glasses (i)-(iv). Note that the expression “including 0-25 mol % of MgO” used in the present specification means that MgO is not necessarily included but may be included up to 25 mol %. A glass described in (i) is included as a soda-lime silicate glass, and glasses described in (ii) or (iii) are included as an aluminosilicate glass.

(i) A glass including SiO₂ of 63-73 mol %, Al₂O₃ of 0.1-5.2 mol %, Na₂O of 10-16 mol %, K₂O of 0-1.5 mol %, Li₂O of 0-5.0 mol %, MgO of 5-13 mol %, and CaO of 4-10 mol %.

(ii) A glass including SiO₂ of 50-74 mol %, Al₂O₃ of 1-10 mol %, Na₂O of 6-14 mol %, K₂O of 3-11 mol %, Li₂O of 0-5.0 mol %, MgO of 2-15 mol %, CaO of 0-6 mol %, and ZrO₂ of 0-5 mol %, in which a sum of SiO₂ and Al₂O₃ is not more than 75 mol %, a sum of Na₂O and K₂O is 12-25 mol %, and a sum of MgO and CaO is 7-15 mol %.

(iii) A glass including SiO₂ of 68-80 mol %, Al₂O₃ of 4-10 mol %, Na₂O of 5-15 mol %, K₂O of 0-1 mol %, Li₂O of 0-5.0 mol %, MgO of 4-15 mol %, and ZrO₂ of 0-1 mol %.

(iv) A glass including SiO₂ of 67-75 mol %, Al₂O₃ of 0-4 mol %, Na₂O of 7-15 mol %, K₂O of 1-9 mol %, Li₂O of 0-5.0 mol %, MgO of 6-14 mol %, and ZrO₂ of 0-1.5 mol %, in which a sum of SiO₂ and Al₂O₃ is 71-75 mol %, and a sum of Na₂O and K₂O is 12-20 mol %, and in which CaO less than 1 mol % may be included.

In order that a chemical toughening process is appropriately applied to a glass, a sum of Li₂O and Na₂O contained in the glass is preferably not less than 12 mol %. Additionally, as a rate of content of Li₂O in the glass increases, a glass transition point becomes lower and shaping of the glass becomes easier. Therefore, a rate of content of Li₂O in the glass is preferably not less than 0.5 mol %, more preferably not less than 1.0 mol %, and further more preferably not less than 2.0 mol %. Further, to increase surface compressive stress (CS) and depth of compressive stress layer (DOL), composition of the glass including SiO₂ not less than 60 mol % and Al₂O₃ not less than 8 mol % is preferable.

A maximum CS of a glass to which a chemical toughening process is applied is not less than 400 MPa, preferably not less than 500 MPa, and more preferably not less than 600 MPa. In addition, the DOL is not less than 10 μm. By setting CS and DOL within the above described range, good strength and scratch resistance can be given to a main surface of a glass.

In a chemical toughening process, alkali metal ions having a small ion diameter (typically, Na ions) in a surface of a glass are exchanged with other alkali metal ions having larger ion diameter (typically K ions) at a temperature not higher than a glass transition point, to form a compressive stress layer in the surface of the glass. The chemical toughening process can be performed by a conventional method. Generally, the glass is immersed in a molten salt such as molten potassium nitrate. Also, mixed salt containing potassium nitrate and potassium carbonate can be used as a molten salt, and preferably, in the mixed salt of 100 parts by mass, potassium carbonate of 5-10 parts by mass should be contained. By using this mixed salt, cracks or the like on a surface of the glass can be removed and a glass having high strength can be obtained. Further, by adding a silver ingredient such as silver nitrate to potassium nitrate in a chemical toughening process, antibacterial property is given to the glass plate since silver ions are provided on the surface of the glass by ion exchange.

A glass plate having a curved surface may be manufactured by forming a flat-shaped glass plate into a desired shape. As for a forming method, when a plate-glass is used as a flat-shaped glass plate for example, an appropriate forming method may be selected among a self-weight forming method, a vacuum forming method, and a press forming method, in accordance with a desired curved shape of a glass plate to be formed.

In the self-weight forming method, after a plate-glass is placed on a mold having a shape corresponding to a desired curved shape of the plate-glass, the plate-glass is softened. the softened plate-glass is bent by gravity along the shape of the mold, thereby the plate-glass is formed into the desired shape.

In the vacuum forming method, to form a plate-glass into a desired curved shape, different pressures are given to respective surfaces of the plate-glass with the plate-glass softened, so that the plate-glass is bent along a mold. In the vacuum forming method, the plate-glass is placed on the mold having a shape corresponding to the desired curved shape of the plate-glass, and a periphery of the plate-glass is sealed. After the sealing, by decompression of the air between the mold and the plate-glass, different pressures are given to both an upper surface and a lower surface of the plate-glass respectively. The upper surface of the plate-glass may be pressurized supplementally.

In the press forming method, a plate-glass is placed between a combination of molds (lower mold and upper mold) having a shape corresponding to a desired curved shape of the plate-glass, then a pressing load is applied to both the upper mold and the lower mold with the plate-glass softened, to bend the plate-glass along the shape of the molds, and thereby the plate-glass is foamed into the desired shape.

Among these methods, the vacuum forming method is superior as the method for forming a glass into a curved shape. In the vacuum forming method, since the glass plate can be formed without a contact of the mold with one of the main surfaces of the glass plate, concave-convex defects such as scratches or dents are lass likely to be made on the glass plate.

Besides the methods described above, a local heating forming method, a differential pressure forming method which is different from a vacuum forming method, or the like, may be used. An appropriate forming method may be selected in accordance with a desired curved shape of a glass plate to be formed. Further, multiple methods may be used together.

Also, a process for reducing residual stress may be applied by re-heating (annealing) a glass plate after forming.

Furthermore, a flat glass plate to be used may include an etching layer or a coating layer formed by a wet coating or a dry coating.

Uses for a glass plate formed by the method according to the present embodiment are not limited to specific ones. Examples of the uses include a transparent part for a vehicle (such as a headlight cover, a side mirror, a transparent base plate for front window, a transparent base plate for side window, a transparent base plate for rear window, a surface of an instrument panel), a meter, a window of a building, a show window, an interior of a building, an exterior of a building, a display (for a laptop PC, a monitor, an LCD, a PDP, an ELD, a CRT, a PDA, and the like), a color filter for LCD, a substrate for touch panel, a pickup lens, an optical lens, an eyeglass lens, a camera component, a video recorder/player component, a cover substrate for CCD, an end surface of an optical fiber, a projector component, a photocopier component, a transparent substrate for a solar cell (such as a cover glass), a window of a cellular phone, a part of a backlight unit (such as a light-guiding plate, a cold-cathode tube), a brightness enhancement film for LCD backlight unit (such as a prism, a translucent film), a brightness enhancement film for LCD, a light emitting element component for an organic EL, a light emitting element component for an inorganic EL, a light emitting element component for a phosphor, an optical filter, an end surface of an optical component, an illumination lamp, a cover for a lighting equipment, an amplifier laser source, an anti-reflective film, a polarizing film, and a film for agriculture.

An article according to the present invention is equipped with the glass plate according to the present invention.

The article according to the present invention may consist of the glass plate according to the present embodiment, or may include members other than the glass plate according to the present embodiment.

Examples of the article according to the present invention include articles that are described above as the uses for the glass plate, apparatuses equipped with at least one of the articles, and the like.

Examples of the apparatuses include an image display device, a lighting device, a solar cell module, and the like.

The article according to the present invention is preferably an image display device from perspectives of optical properties such as a uniform visibility and the like. Especially, the glass plate according to the present embodiment is suitable for a display device in which the glass plate is laminated with a liquid crystal panel or an organic EL panel, where a glass plate having a large-scale curved shape is in demand, and additionally suitable for a display device used for vehicles having a complex curved shape. According to the embodiments described above, even a glass plate having a complex curved shape can be polished uniformly, thereby a uniform visibility can be ensured.

What is claimed is:

1. A method for manufacturing a glass plate comprising a polishing step of polishing a curved surface of the glass plate using a polisher;
wherein the polisher is a rotating brush comprising a rotating core and brush bristles provided on an external surface of the rotating core, an average diameter of the brush bristle being not more than 300 μm, and
wherein in the polishing step, a position of the rotating brush relative to the glass plate is reciprocated along an axial direction of the rotating brush.

2. The method according to claim 1,
wherein a reciprocating speed of the rotating brush is not less than 1 mm/sec and reciprocating amplitude of the rotating brush is not less than 0.5 mm.

3. The method according to claim 1,
wherein a reciprocating speed of the rotating brush is not less than 1 mm/sec and reciprocating amplitude of the rotating brush is not less than 3 mm.

4. The method according to claim 1, wherein an opposite surface of the curved surface of the glass plate is vacuum-adhered to a curved surface of a base in the polishing step.

5. The method according to claim 4, wherein the base is rotated in the polishing step.

6. The method according to claim 1, wherein a portion of the base with which the glass plate is in contact is made of a resin material of at least one of polyvinyl chloride, polycarbonate, polyacetal, acryl, polyamide, polyurethane, and polypropylene.

7. A glass plate with a thickness within a range of 0.5-3.0 mm comprising a curved surface;
wherein, on at least a part of the curved surface,
an arithmetical mean height (Sa) of a frequency component corresponding to a wavelength range from 25 to 500 μm is 0.5-50 nm, and
a ratio (Waₘₐₓ/Waₘᵢₙ) of a maximum (Waₘₐₓ) to a minimum (Waₘᵢₙ) of an arithmetical mean waviness (Wa) of the frequency component corresponding to the wavelength range from 25 to 500 μm is not less than 1.5.

8. A glass plate with a thickness within a range of 0.5-5.0 mm comprising a first surface and a second surface, the first surface and the second surface comprising a curved surface;
wherein a surface compressive stress (CS) of the glass plate is not less than 400 MPa, and
on at least a part of the curved surface, an arithmetical mean height (Sa) of a frequency component corresponding to a wavelength range from 25 to 500 μm is 0.5-50 nm, and a ratio (Waₘₐₓ/Waₘᵢₙ) of a maximum (Waₘₐₓ) to a minimum (Waₘᵢₙ) of an arithmetical mean waviness (Wa) of the frequency component corresponding to the wavelength range from 25 to 500 μm is not less than 1.5.

9. The glass plate according to claim 8, wherein a surface treatment layer is formed on the first surface.

10. The glass plate according to claim 7, wherein, on at least a part of the curved surface, a number of defects whose maximum diameter is not less than 7 μm and whose depth or height is not less than 1 μm is less than 4 per 10000 mm².

11. A display device comprising the glass plate according to claim 7 and a display panel.
